(19) United States
(12) Patent Application Publication
(10) Pub. No.: US 2024/0053194 A1
(43) Pub. Date: Feb. 15, 2024

(54) Systems With Glass Layers

(71) Applicant: Apple Inc., Cupertino, CA (US)

(72) Inventors: Tyler A. Marshall, Fremont, CA (US); Divakar Singamsetty, San Jose, CA (US); Jeremy C. Franklin, San Francisco, CA (US); Jeffrey C. Olson, San Francisco, CA (US); Matthew S. Rogers, San Jose, CA (US)

(21) Appl. No.: 18/347,942

(22) Filed: Jul. 6, 2023

Related U.S. Application Data
(60) Provisional application No. 63/397,947, filed on Aug. 15, 2022.

(51) Int. Cl. G01J 1/04; G01J 1/02

(52) U.S. Cl. CPC G01J 1/0407; G01J 1/0271

(57) ABSTRACT

A system may have a support structure and a glass layer that separate an exterior region surrounding the system from an interior region. Components may be mounted in the interior region. The components may include an optical component. The glass layer may have a first area that overlaps the optical component and that serves as an optical component window for the optical component. The glass layer may also have a second area that surrounds the first area and does not overlap the optical component. The first area may be selectively weakened relative to the second area to prevent excessive glass fracturing during a damage event from obscuring the optical component. Selective weakening may be provided with laser-induced-damage features, recesses from local thinning, and/or glass-weakening deposited thin films such as physical vapor deposition thin-film coatings of inorganic dielectric.

This application claims the benefit of provisional patent application No. 63/397,947, filed Aug. 15, 2022, which is hereby incorporated by reference herein in its entirety.

### FIELD

This relates generally to glass structures, and, more particularly, systems with glass layers that overlap optical components.

### BACKGROUND

Systems sometimes include glass layers. In some systems, glass layers overlap optical components.

### SUMMARY

A system may have support structures and a glass layer that separate an exterior region surrounding the system from an interior region. Components may be mounted in the interior region. The components may include sensors, light-emitting devices, and other components. One or more optical components may be included in the system.

The glass layer may have a first area that overlaps an optical component and that serves as an optical component window for the optical component. The glass layer may also have a second area that surrounds the first area and does not overlap the optical component. The first area may be selectively weakened relative to the second area to prevent excessive glass fracturing in the first area during an impact or other damage-inducing event. This may help prevent fractured glass in the optical component window from interfering with operation of the optical component. Selective weakening of the first area may be provided using laser-induced-damage features, local thinning, and/or deposited thin-films such as physical vapor deposition of thin-film inorganic dielectric.

### BRIEF DESCRIPTION OF THE DRAWINGS

FIG. 1A is a diagram of an illustrative system with a glass layer in accordance with an embodiment.

FIG. 1B is a cross-sectional side view of an illustrative glass layer with a curved cross-sectional profile in accordance with an embodiment.

FIGS. 2, 3, and 4 are cross-sectional side views of illustrative glass layers in accordance with embodiments.

FIGS. 5, 6, and 7 are top views of illustrative glass layers with optical component window regions in accordance with embodiments.

### DETAILED DESCRIPTION

Systems may be provided with components that emit and/or detect light. These components, which may sometimes be referred to as optical components, may be overlapped by glass layers. A glass layer may, for example, serve as a protective cover for one or more overlapped components and other system structures.

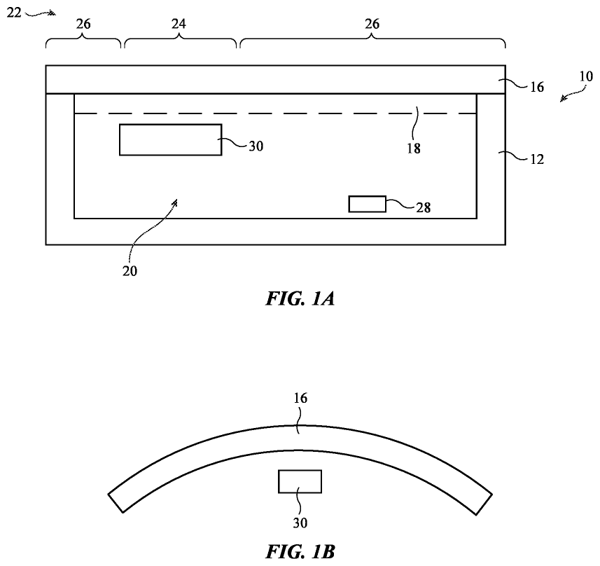

FIG. 1A is side view of an illustrative system. As shown in FIG. 1A, system 10 may include a glass layer such as glass layer 16. If desired, one or more additional layers of material such as optional inner polymer layer 18 may be laminated to layer 16. Layer 16 and optional layer 18 may be transparent and may overlap one or more optical components such as optical component 30.

System 10 may be an electronic device (e.g., a portable electronic device or other electronic equipment), may be a vehicle, may be a building, may be an embedded system (e.g., electronic equipment mounted in a kiosk), and/or may be by any other suitable system. Layer 16 may be mounted in a support structure such as support structure 12 (e.g., a device housing, a structural body of a large system, walls and/or other structures in a building, etc., sometimes referred to as a support or housing). Layer 16 and support structure 12 may separate interior region 20 of system 10 from exterior region 22 surrounding system 10. Components 28 (e.g., integrated circuits, batteries, input-output circuitry, communications circuitry, etc.) may be mounted in interior region 20.

The components mounted in interior region 20 may include optical components such as optical component 30. Optical component 30 may be an electrical component that emits light and/or that detects light. The emitted and/or detected light may be infrared light, visible light, and/or ultraviolet light. Examples of optical components 30 include light sensors such as photodetectors, image sensors (e.g., infrared cameras, visible cameras, etc.), two-dimensional optical sensors (e.g., two-dimensional cameras), three-dimensional optical sensors (e.g., structured light three-dimensional image sensors, image sensors that capture three-dimensional images using a binocular pair of two-dimensional image sensors, time-of-flight sensors that capture three-dimensional images using time-of-flight principles, etc.), lidar, proximity sensors (e.g., infrared proximity sensors that emit light and measure corresponding reflected light after the emitted light has reflected from external objects), color and monochrome ambient light sensors, and/or other infrared and/or visible light sensors configured to detect infrared and/or visible light. Optical components 30 may also include light sources such as light-emitting diodes, lasers, lamps, displays, etc. Layer 16 and optional layers such as layer 18 may be transparent, so that light that is emitted by component 30 may pass from interior region 20 to exterior region 22 through these layers and/or so that light from exterior region 22 may be received and detected by component 30 (e.g., an infrared or visible light sensor) after passing through these layers.

As shown in FIG. 1A, glass layer 16 may include a first portion that overlaps component 30 such as the portion under optical component window area 24 (sometimes referred to as optical window area 24, optical window 24, etc.) and may have a second portion that does not overlap component 30 such as the portion in non-overlapped (non-window) area 26 surrounding area 24.

As shown in FIG. 1B, glass layer 16 and the portion of layer 16 that overlaps optical component 30 may have a curved cross-sectional profile. Layer 16 may be bent about a single bend axis and/or may have portions that are characterized by compound surface curvature.

Glass layer 16 may be formed from soda lime glass and/or other suitable glass. To enhance the ability of glass layer 16 to resist damage, glass layer 16 may be chemically strengthened. During chemical strengthening, the opposing outer and inner surfaces of layer 16 are placed in compression and the embedded center of layer 16 exhibits tensile stress. The compressively stressed outer portions of layer 16 help prevent crack propagation and breakage of layer 16. The thickness of glass layer 16 may be at least 0.1 mm, at least 0.2 mm, at least 0.4 mm, at least 0.8 mm, at least 1.6 mm, at least 5 mm, less than 6 mm, less than 2 mm, less than 1.4 mm, less than 0.7 mm, 0.3-1.2 mm, 0.4-1.0 mm, 0.1.1 mm, and/or other suitable thickness.

The glass that forms layer 16 may be inherently brittle. For example, layer 16 may have a relatively high modulus of elasticity of about 75 GPa to 105 GP to help layer 16 resist scratches and other damage and thereby help enhance the reliability of layer 16. The high modulus of layer 16 may make layer 16 subject to fracturing during severe impact events when layer 16 is accidentally dropped onto a hard surface or otherwise abruptly collides with an external object. When layer 16 fractures during an undesired impact event, a network of cracks may spread across the surface of layer 16.

To help ensure that optical component 30 continues to operate satisfactorily in the event that glass layer 16 is subjected to fracturing, the portion of layer 16 overlapping component 30 (e.g., area 24 of FIG. 1A) may be locally modified relative to the portion of layer 16 that is not overlapping component 30 (e.g., area 26 of FIG. 1A). The local modification of layer 16 reduces the strength of overlapping area 24 relative to non-overlapping area 26. The lowered strength of area 24 helps to prevent excessive fracturing of glass 16 when glass 16 is damaged. For example, non-overlapping area 26 may be characterized by small fractured pieces of glass and closely spaced cracks upon fracturing, whereas area 24 may be characterized by larger fractured pieces and more widely spaced cracks (or, in some scenarios no fractured pieces or cracks). The local modification of layer 16 therefore allows non-overlapping area 26 to have a sufficiently high strength to provide layer 16 with a desired reliability during impact events, while also allowing overlapping area 24 to have a sufficiently low strength to avoid excessive fracturing that could compromise the operation of overlapped components such as component 30. Area 24 may occupy less than 50% of area 26, less than 20% of area 26, less than 10% of area 26 or other fraction of area 26. Because only some of glass layer 16 has locally reduced strength strength, layer 16 may maintain an overall high level of reliability.

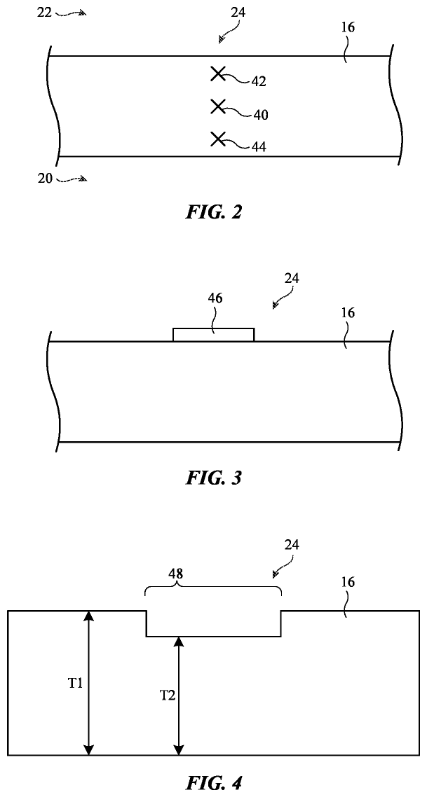

FIGS. 2, 3, and 4 are cross-sectional side views of glass layer 16 showing illustrative configurations for locally reducing the strength of glass layer 16 in area 24.

With one illustrative approach, a laser tool focuses laser light onto one or both surfaces of layer 16 and/or the laser tool focuses laser light into an interior portion of layer 16. This locally damages layer 16 and decreases the strength of layer 16 in area 24 relative to area 26. As shown in FIG. 2, laser-induced damage may be created at locations such as location 42 (near exterior region 22), central location 40 (at or near the middle of the thickness of layer 16), and/or location 44 (near interior region 20). Laser-induced-damage may include dots, strips, zig-zag patterns, circles, and/or other patterns of features (sometimes referred to as laser-induced damage structures, laser-induced damage areas, laser-induced damage regions, etc.). Dots and other shapes of laser-induced damage may be formed in arrays (e.g., two-dimensional arrays having rows and columns, arrays with dots formed in randomized patterns, arrays where dots radiate outward from a central point, etc.). If desired, the lateral dimensions of laser-induced-damage features may be sufficiently small to be unnoticeable to an unaided eye and/or sufficiently small to avoid disrupting the operation of component 30 (e.g., the lateral dimensions of the laser-induced-damage features may be 2-50 microns, at least 2 microns, at least 5 microns, at least 10 microns, less than 200 microns, less than 100 microns, or other suitable size.

In the example of FIG. 3, a strength-lowering layer (layer 46) has been formed in area 24. The thickness of layer 46 may be 0.01-2 microns, 0.05-1.0 microns, less than 1 micron, less than 0.5 microns, or other suitable thickness. Layer 46 may be an inorganic thin-film layer such as a layer of silicon nitride or other thin-film material having a modulus of elasticity greater than that of layer 16. If, as an example, layer 16 is formed from glass having a modulus of elasticity of 75 GPa to 105 GPa, layer 16 may be formed from a material having a modulus of elasticity of greater than that of layer 16 (e.g., greater than 105 GPa, as an example). Layer 46 may be deposited by physical vapor deposition (PVD) or other deposition processes. Layer 46 may be patterned by shadow masking, chemical etching, laser processing, and/or other patterning techniques. Layer 46 may be brittle and may tend to crack more easily than layer 16 due to the elevated modulus of layer 46. Cracks that form in layer 46 may then propagate into layer 16. In this way, covering some or all of area 24 with layers such as layer 46 may help locally reduce glass strength.

In the example of FIG. 4, layer 16 has been locally thinned by creating recess 48 using grinding, drilling, dry and/or wet chemical etching, laser processing, and/or other processing techniques. The overall thickness of layer 16 in non-modified regions is T1, whereas locally modified area 24 contains a locally thinned portion of layer 16 that is characterized by thickness T2. The value of T1 may be at least 0.1 mm, at least 0.2 mm, at least 0.4 mm, at least 0.8 mm, at least 1.6 mm, at least 5 mm, less than 6 mm, less than 2 mm, less than 1.4 mm, less than 0.7 mm, 0.3-1.2 mm, 0.4-1.0 mm, 0.1.1 mm, and/or other suitable thickness. The value of T2 may be 85% of T1 or less, may be 75% of T1 or less, may be 65% of T1 or less, may be 50% of T1 or less, may be 40% of T1 or more, may be 50% of T1 or more, may be 60% of T1 or more, may be 50-80% of T1, may be 55%-75% of T1, or may be any other suitable thickness less than T1. Locally thinned portions, which may sometimes be referred to as recesses, may include pits, grooves, and/or other features of reduced thickness.

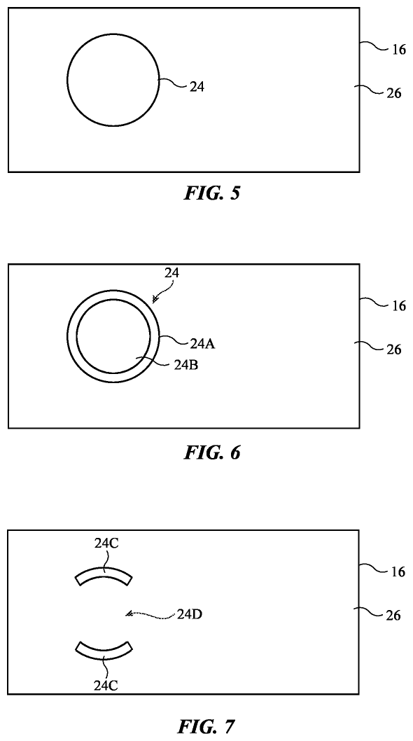

Some or all of area 24 may be covered with strength-reducing features (sometimes referred to as weakening features, weakening structures, weakening, weakening regions, weakened areas, etc.). The weakening structures may include laser-damage, thin-film coatings, areas of glass having recesses that create local weakening thickness reductions, etc.). In the example of FIG. 5, region 24 is entirely covered with strength-reducing features. In the example of FIG. 6, region 24 has a ring-shaped area 24A of strength-reducing features surrounding a central area with fewer or no strength-reducing features (area 24B). In the example of FIG. 7, area 24 includes two partial ring-shaped segments of strength-lowering features (ring segment areas 24C) that are formed on either side of central region 24D (which may have fewer or no strength-reducing features). Other approaches and/or combinations of these approaches may be used (e.g., arrangements in which one or more of areas 24 of FIG. 5, 24A and/or 24B of FIG. 6, and/or area 24C and/or 24D are provided with a PVD coating, a recess, and/or laser-induced-damage). In general, area 24 may have a shape (e.g., an outline or footprint when viewed from above) that is circular, rectangular, triangular, hexagonal, and/or that has other suitable shapes (e.g., shapes with one or more curved and/or straight edges) for serving as a reduced-strength optical window for component 30. The shape of area 24 may be configured to overlap one or more optical components such as optical component 30 so that optical component 30 can operate through area 24 (e.g., by emitting light that passes outwardly through layer 16 in area 24 and/or by receiving light that passes inwardly through layer 16 in area 24). In this way, area 24 serves as an optical component window for one or more overlapped optical components 30 and is therefore sometimes referred to as an optical component window region, optical component window, locally weakened window region, locally weakened optical component window, optical component window of locally reduced strength, locally weakened optical component window region, etc.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

The foregoing is merely illustrative and various modifications can be made to the described embodiments. The foregoing embodiments may be implemented individually or in any combination.

What is claimed is:

1. A portable electronic device, comprising:
an electronic device housing;
a light sensor in an interior region of the electronic device housing; and
a glass layer coupled to the electronic device housing that has a locally weakened optical window region that overlaps the light sensor.

2. The portable electronic device defined in claim 1 wherein the light sensor comprises a light sensor selected from the group consisting of: a photodetector, an image sensor, a time-of-flight sensor, and a structured-light sensor.

3. The portable electronic device defined in claim 2 wherein the locally weakened optical window region has a strength that is lower than other regions of the glass layer.

4. The portable electronic device defined in claim 1 wherein the locally weakened optical window region comprises laser-induced damage.

5. The portable electronic device defined in claim 1 wherein the locally weakened optical window region comprises a thin-film layer on the glass layer.

6. The portable electronic device defined in claim 5 wherein the thin-film layer comprises an inorganic dielectric layer.

7. The portable electronic device defined in claim 6 wherein the glass layer has a first modulus of elasticity, wherein the inorganic dielectric layer comprises a second modulus of elasticity, and wherein the second modulus of elasticity is greater than the first modulus of elasticity.

8. The portable electronic device defined in claim 1 wherein the locally weakened optical window region comprises a portion of the glass layer with a locally reduced thickness.

9. The portable electronic device defined in claim 1 wherein the glass layer has a first thickness outside of the locally weakened optical window region and has at least one portion in the locally weakened optical window region with a second thickness that is less than the first thickness.

10. The portable electronic device defined in claim 1 wherein the locally weakened optical window region includes an array of laser-damaged areas.

11. The portable electronic device defined in claim 10 wherein the laser-damaged areas have lateral dimensions of 2-50 microns.

12. The portable electronic device defined in claim 1 wherein the locally weakened optical window region comprises a ring-shaped area of locally weakened glass.

13. The portable electronic device defined in claim 1 wherein the locally weakened optical window region comprises a circular locally weakened optical window region.

14. The portable electronic device defined in claim 1 wherein the locally weakened optical window region includes a physical vapor deposition coating configured to weaken the glass layer in the locally weakened optical window region.

15. A system, comprising:
a housing separating an interior region from an exterior region;
a light sensor in the interior region; and
a glass layer coupled to the housing between the interior region and the exterior region, wherein the glass layer has a first area that overlaps the light sensor and forms an optical window for the light sensor and has a second area that surrounds the first area and wherein the glass layer in the first area is locally weakened relative to the glass layer in the second area.

16. The system defined in claim 15 wherein the light sensor comprises a visible light sensor.

17. The system defined in claim 15 wherein the light sensor comprises an infrared light sensor.

18. The system defined in claim 15 wherein the first area includes laser-induced damage.

19. The system defined in claim 15 wherein the first area comprises a selected one of: a recess in the glass layer and a physical vapor deposition coating on the glass layer.

20. A system, comprising:
a light sensor; and
a glass layer having a first area that is configured to pass light to the light sensor and having a second area that surrounds the first area and that does not overlap the light sensor, wherein the first area is weaker than the second area.
